(19) United States
(12) Patent Application Publication
(10) Pub. No.: US 2013/0284012 A1
(43) Pub. Date: Oct. 31, 2013

(54) VACUUM BRAKE BOOSTER

(71) Applicant: ADVICS CO., LTD., Kariya-city (JP)

(72) Inventors: Yoshiyuki YASUI, Chiryu-shi (JP); Tomoyasu SAKAI, Kariya-shi (JP)

(73) Assignee: ADVICS CO., LTD., Kariya-city (JP)

(21) Appl. No.: 13/870,557

(22) Filed: Apr. 25, 2013

(30) Foreign Application Priority Data
Apr. 25, 2012 (JP) 2012-099617

(51) Int. Cl. B60T 13/569

(52) U.S. Cl. CPC B60T 13/569
USPC 91/369.2; 91/376 R

(57) ABSTRACT

In a vacuum brake booster, a valve mechanism having a negative pressure valve which communicates and cuts off between a negative pressure chamber and a variable pressure chamber according to a retractable movement of the plunger with respect to a valve body, and an atmosphere valve which communicates and cuts off between the variable pressure chamber and the atmosphere is assembled in a shaft hole of a valve body. In addition, the plunger and the key member are assembled in the shaft hole. In addition, in the vacuum brake booster, when the valve body is in the forward moving position and the plunger is moved rearward from the forward moving position, a protrusion tilting and holding the key member with respect to the valve body is provided.

### TECHNOLOGICAL FIELD

The present invention relates to a vacuum brake booster that is one component of a brake system applied to a vehicle.

### BACKGROUND DISCUSSION

Generally, a vacuum brake booster includes a movable partition wall which defines a forward negative pressure chamber and a rearward variable pressure chamber within a housing; a valve body which is retractably assembled in the housing and connected to the movable partition wall inside the housing; a valve mechanism having a negative pressure valve which is assembled inside a shaft through hole included in the valve body and which communicates and cuts off between the negative pressure chamber and the variable pressure chamber, and an atmosphere valve which communicates and cuts off between the variable pressure chamber and the atmosphere; a plunger which configures a portion of the valve mechanism and which is retractable with respect to the valve body in an axial direction thereby integrally moving with an input member; a reaction member which is assembled inside the shaft through hole forward from the plunger such that a front end portion of the plunger and a front end portion of the valve body are engageable with its rear surface; an output member of which a rear end portion engages with a front surface of the reaction member and which is movable with respect to valve body in the axial direction; and a key member which is able to engage and disengage with the valve body, the plunger and the housing, and which defines a moving amount of the plunger with respect to the valve body in a front-back direction, and which defines a rearward moving limit position of the valve body with respect to the housing. Such a vacuum brake booster is, for example, disclosed in JP-A-9-295570.

The vacuum brake booster disclosed in JP-A-9-295570 employs a configuration in which, in the process of returning from an operating state of the vacuum brake booster to a non-operating state thereof, a hitting sound is reduced in a portion (an abutment portion) of a seal member (an elastic member) when a key member abuts a housing (a rearward shell) in a late stage of the returning process. In such a configuration, the hitting sound described above is reduced by an elastic deformation of a portion (the abutment portion) of the seal member (the elastic member).

However, in the vacuum brake booster disclosed in JP-A-9-295570 described above, in the non-operating state (the returned state), since a portion (an abutment portion) of the seal member (the elastic member) is in an always compressed and deformed state, the hitting sound reduction effect may be reduced by secular change or the like (elastic degradation or the like). In addition, in the vacuum brake booster disclosed in JP-A-9-295570 described above, it is possible to reduce the hitting sound (the hitting sound in the late stage of the returning operation) when the key member abuts the housing (the rearward shell); however, the hitting sound of the initial stage of the returning operation cannot be reduced. In addition, when the valve body, the plunger, the key member and the like are returned from the operating state to the non-operating state, the plunger is moved rearward with the key member from a forward moving position with respect to the valve body which is in the forward moving position (the operating state position). Accordingly, the key member abuts the valve body and then the hitting sound of the initial stage of the returning operation occurs.

### SUMMARY

A vacuum brake booster comprises a movable partition wall which defines a forward negative pressure chamber and a rearward variable pressure chamber within a housing; a valve body which is retractably assembled in the housing and connected to the movable partition wall inside the housing; a valve mechanism having a negative pressure valve which is assembled inside a shaft through hole included in the valve body and which communicates and cuts off between the negative pressure chamber and the variable pressure chamber, and an atmosphere valve which communicates and cuts off between the variable pressure chamber and the atmosphere; a plunger which configures a portion of the valve mechanism and which is retractable with respect to the valve body in an axial direction, thereby integrally moving with an input member; a reaction member which is assembled inside the shaft through hole forward from the plunger such that a front end portion of the plunger and a front end portion of the valve body are engageable with its rear surface; an output member of which a rear end portion engages with a front surface of the reaction member and which is movable with respect to the valve body in the axial direction; a key member which is able to engage and disengage with respect to the valve body, the plunger and the housing, and which defines a moving amount of the plunger with respect to the valve body in a front-back direction and which defines a rearward moving limit position of the valve body with respect to the housing; and a protrusion tilting and holding the key member with respect to the valve body when the valve body is in the forward moving position and the plunger is moved rearward from the forward moving position.

### BRIEF DESCRIPTION OF THE DRAWINGS

FIG. 1 is a cross-sectional view illustrating a main portion (a non-operating state) of a first embodiment of a vacuum brake booster according to the invention.

FIG. 2 is a side view illustrating a relationship between a valve body and a key member illustrated in FIG. 1.

FIG. 3 is a cross-sectional view illustrating an operating state of the vacuum brake booster illustrated in FIG. 1.

FIG. 4 is a cross-sectional view illustrating an operation in which a plunger is moved with a key member rearward with respect to the valve body and the key member abuts a protrusion of the valve body (when tilting of the key member is started), at an initial stage of the period in which the vacuum brake booster (the operating state) illustrated in FIG. 3 is returned to the non-operating state.

FIG. 5 is a cross-sectional view illustrating the operation in which the plunger is moved with the key member more rearward with respect to the valve body and tilts in a state where the key member abuts the protrusion of the valve body, and then abuts the valve body at a position other than the protrusion (when the tilting of the key member is finished), when the vacuum brake booster illustrated in FIG. 4 is returned more to the non-operating state.

FIG. 6 is a cross-sectional view illustrating the operation in which one end portion of the key member abuts the housing in a tilt holding state at a late stage of the period in which the vacuum brake booster illustrated in FIG. 5 is returned to the non-operating state.

FIG. 7 is a side view illustrating a relationship between the valve body and the key member in a case where the number of the protrusion provided on the valve body is one.

FIG. 8 is a cross-sectional view illustrating a main portion (the non-operating state) of a second embodiment of the vacuum brake booster according to the invention.

FIG. 9 is a cross-sectional view illustrating a main portion (the non-operating state) of a third embodiment of the vacuum brake booster according to the invention.

### DETAILED DESCRIPTION OF THE INVENTION

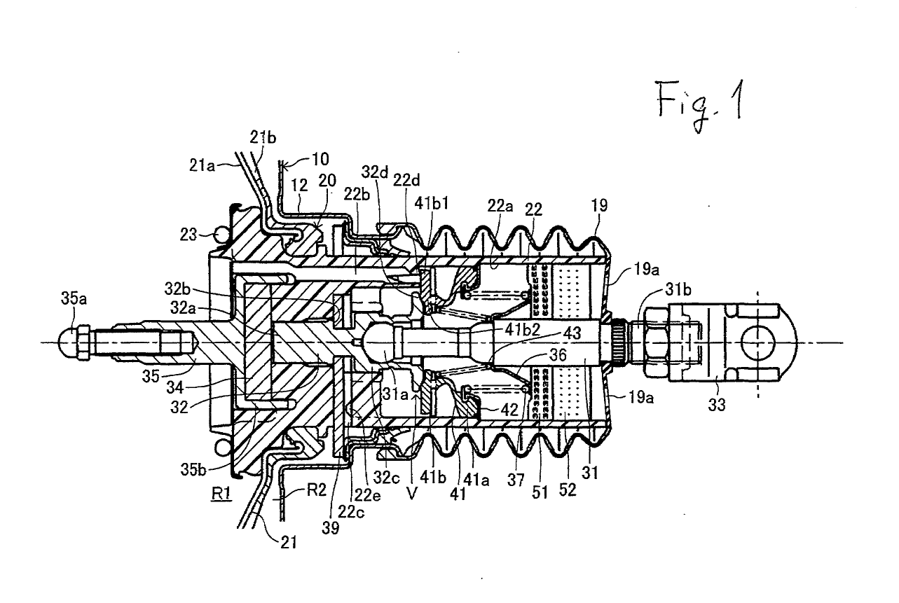

Hereinafter, each of embodiments of the invention will be described, based on the drawings. FIG. 1 illustrates the first embodiment of the vacuum brake booster according to the invention. In the vacuum brake booster of the first embodiment, a power piston 20 including a movable partition wall 21 and a valve body 22 is assembled in a housing 10 movably in a front-back direction (a left-right direction in FIG. 1) and then the inside of the housing 10 is defined to a forward negative pressure chamber R1 and a rearward variable pressure chamber R2 by the movable partition wall 21.

The housing 10 includes a forward shell (not illustrated) and a rearward shell 12, and includes a negative pressure introducing pipe (not illustrated) which is airtightly provided in the forward shell and which allows the negative pressure chamber R1 to usually communicate with a negative pressure source (for example, an intake manifold (not illustrated) of an engine). The housing 10 is fixed to a stationary member, that is, a vehicle body (not illustrated) by using a plurality of mounting bolts (not illustrated) airtightly passing through the rearward shell 12, and is configured so as to support a brake master cylinder (not illustrated) by using a plurality of mounting bolts (not illustrated) airtightly passing through the forward shell.

The brake master cylinder is known in the related art and is airtightly assembled to the forward shell at a rear end portion of a cylinder body (not illustrated) thereof. In addition, a piston (not illustrated) of the brake master cylinder is configured so as to protrude rearward from the cylinder body and irrupt in the negative pressure chamber R1, and so as to be pushed forward by a front end portion 35a of an output shaft 35 described below.

The movable partition wall 21 of the power piston 20 is configured of a circular plate 21a and a circular diaphragm 21b, and is disposed movable in the front-back direction (an axial direction of the power piston 20) inside the housing 10. The diaphragm 21b is airtightly fitted into the housing 10 at a circular outer peripheral bead portion (not illustrated) formed in an outer periphery thereof. In addition, the diaphragm 21b is airtightly fixed to an outer periphery portion of the valve body 22 with an inner periphery portion of the plate 21a at a circular inner peripheral bead portion formed in an inner peripheral edge thereof.

The valve body 22 of the power piston 20 is a hollow body made of a resin, which is connected to the inner periphery portion of the movable partition wall 21 inside the housing 10, and is assembled airtightly and movable (retractably movable with respect to the housing 10) in the front-back direction (the axial direction of the power piston 20) to the rearward shell 12 of the housing 10 at a middle portion which is formed in a cylindrical shape. In addition, the valve body 22 is biased rearward by a return spring 23 interposed between the forward shell of the housing 10 and the valve body 22. In addition, portions protruding outside the housing 10 of the valve body 22 are covered and protected by a boot 19 having a plurality of ventilation holes 19a at a rear end thereof.

In addition, a stepped shaft hole 22a passing through the valve body 22 in the front-back direction is formed in the valve body 22. In addition, in the valve body 22, a pair (only one is illustrated in FIG. 1) of negative pressure communication path 22b which communicates with a middle stepped portion of the shaft hole 22a at the rear end thereof and which communicates with the negative pressure chamber R1 at the front end thereof, and a key mounting hole 22c which is substantially orthogonal to the shaft hole 22a at a forward portion thereof and into which a key member 39 is able to be inserted from outside are formed.

An input shaft 31 and a plunger 32 are coaxially assembled in the shaft hole 22a, and a valve member 41 and filters 51 and 52 are coaxially assembled in the shaft hole 22a. In addition, a reaction member 34 and the output shaft (the output member) 35 are coaxially assembled in the shaft hole 22a described above forward the plunger 32.

The input shaft 31 is configured in such a manner that the input shaft 31 is retractably moved with respect to the valve body 22 in the axial direction and is jointly connected to a receiving-connection section 32c of the plunger 32 at a spherical front end section 31a. In addition, the input shaft 31 is connected to a brake pedal (not illustrated) via a yoke 33 at a rear end thread section 31b so that a pedal force acting on the brake pedal is input and received forward thereof. In addition, the input shaft 31 engages with the return spring 37 via a retainer 36 fitted into the middle stepped portion and is biased rearward by the return spring 37.

The plunger 32 configures a portion of a valve mechanism V described below. The plunder 32 is retractable with respect to the valve body 22 in the axial direction and is integrally moved with the input shaft 31. In addition, the plunger 32 can abut the center portion of the rear surface in the reaction member 34 at the front end portion 32a thereof. The plunder 32 can engage and disengage with the center portion of the key member 39 at a circular groove section 32b formed at the center portion thereof and the front end section 32a partially receives a reaction force of an output from the reaction member 34. In addition, the rear end of the plunger 32 has a circular atmosphere valve section 32d in the valve mechanism V.

The center portion of the rear surface of the reaction member 34 can be bulged and deformed rearward. In addition, the reaction member 34 is assembled to the front end portion (inside the shaft hole 22a) of the valve body 22 with a rearward cylindrical section 35b of the output shaft 35, in a state where the entire front surface of the reaction member 34 is received in the rearward cylindrical section 35b of the output shaft 35 and then engages (abuts) with the rear surface of the rear end portion of the output shaft 35. The reaction member 34 can engage with the front surface of the front end section 32a of the plunger 32 at the rear surface thereof and abuts (engages) a circular front end surface of the valve body 22.

The output shaft 35 is assembled with the reaction member 34 inside the front end portion of the shaft hole 22a of the valve body 22 movably (movable with respect to the valve body 22 in the axial direction) in the front-back direction. Accordingly, the output shaft 35 abuts an engagement portion (a concave portion) of the piston in the brake master cylinder to be pushed at the front end portion (not illustrated) and transmits the reaction force received from the piston of the brake master cylinder to the reaction member 34 during braking operation.

The key member 39 is made of a metal and formed in a fork shape. Accordingly, the key member 39 can engage and disengage with the valve body 22, the plunger 32 and the housing 10 in the axial direction, respectively. In addition, the key member 39 has a function to define a moving amount of the plunger 32 in the front-back direction with respect to the valve body 22 of the power piston 20 and a function to define a rearward moving limit position (a rearward returned position of the valve body 22) of the power piston 20 with respect to the housing 10. Accordingly, the key member 39 is assembled such that the key member 39 is relatively movable with a required amount in the axial direction of the power piston 20 with respect to the valve body 22 and the plunger 32, respectively.

The valve mechanism V is assembled inside the shaft hole 22a of the valve body 22 and includes an arc or circular negative pressure valve seat 22d which is integrally formed with the rear end portion of the negative pressure communication path 22b in the valve body 22; the annular atmosphere valve section 32d which is integrally formed with the rear end portion of the plunger 32; and the cylindrical valve member 41 which is coaxially disposed with respect to the atmosphere valve section 32d and assembled inside the shaft hole 22a of the valve body 22. The valve member 41 has an annular mounting section 41a and a cylindrical movable section 41b which is integrally formed with the mounting section 41a and is movable in the axial direction.

The mounting section 41a is airtightly assembled inside the shaft hole 22a of the valve body 22 and then is fixed and held at a fixed position (a stepped portion) of the shaft hole 22a of the valve body 22 by a retainer 42. In addition, the retainer 42 is biased forward by the return spring 37 so as to fix to the stepped portion of the shaft hole 22a in the valve body 22.

The movable section 41b has a negative pressure valve section 41b1 which can seat and unseat with respect to the negative pressure valve seat 22d and configures a negative pressure valve capable of communicating and cutting off between the negative pressure chamber R1 and variable pressure chamber R2 by the negative pressure valve seat 22d. In addition, the movable section 41b has an annular atmosphere valve seat 41b2 which configures an atmosphere valve capable of communicating and cutting off between the variable pressure chamber R2 and the atmosphere by the atmosphere valve section 32d capable of seat and unseat with respect to the atmosphere valve section 32d. The movable section 41b is biased forward by a compression spring 43.

According to the configuration of the valve mechanism V described above, the variable pressure chamber R2 can communicate with the negative pressure chamber R1 or the atmosphere depending on the movement of the input shaft 31 and the plunger 32 with respect to the valve body 22 in the front-back direction. In other words, when the input shaft 31 and the plunger 32 are moved forward with respect to the valve body 22 from an original position of FIG. 1 (the returned position of the non-operation); the negative pressure valve section 41b1 is seated on the negative pressure valve seat 22d; and when the atmosphere valve section 32d is unseated with respect to the atmosphere valve seat 41b2, the communication of the variable pressure chamber R2 with the negative pressure chamber R1 is cut off and the variable pressure chamber R2 communicates with the atmosphere. At this time, the air flows in the variable pressure chamber R2 through the ventilation holes 19a of the boot 19, the filters 51 and 52, the inside of the valve body 41, a clearance between the atmosphere valve section 32d and the atmosphere valve seat 41b2, a communication path provided in the valve body 22 and the like.

In addition, in a state where the input shaft 31 and the plunger 32 are returned to the returned position (the original position) with respect to the valve body 22; the atmosphere valve section 32d is seated on the atmosphere valve seat 41b2; the negative pressure valve section 41b1 is unseated with respect to the negative pressure valve seat 22d (in other words, in a state where the atmosphere valve is closed, the communication between the variable pressure chamber R2 and the atmosphere is cut off, the negative pressure valve is open, and then the negative pressure chamber R1 communicates with the variable pressure chamber R2), the communication between the variable pressure chamber R2 and the atmosphere is cut off and the variable pressure chamber R2 communicates with the negative pressure chamber R1. At this time, the air is absorbed and flow in the negative pressure chamber R1 from the variable pressure chamber R2 through the communication path provided in the valve body 22, the clearance between the negative pressure valve section 41b1 and the negative pressure valve seat 22d, the negative pressure communication path 22b and the like.

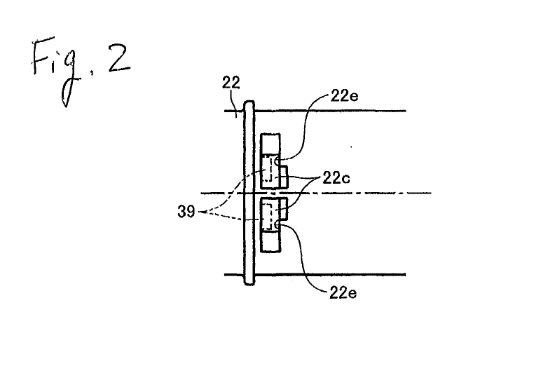

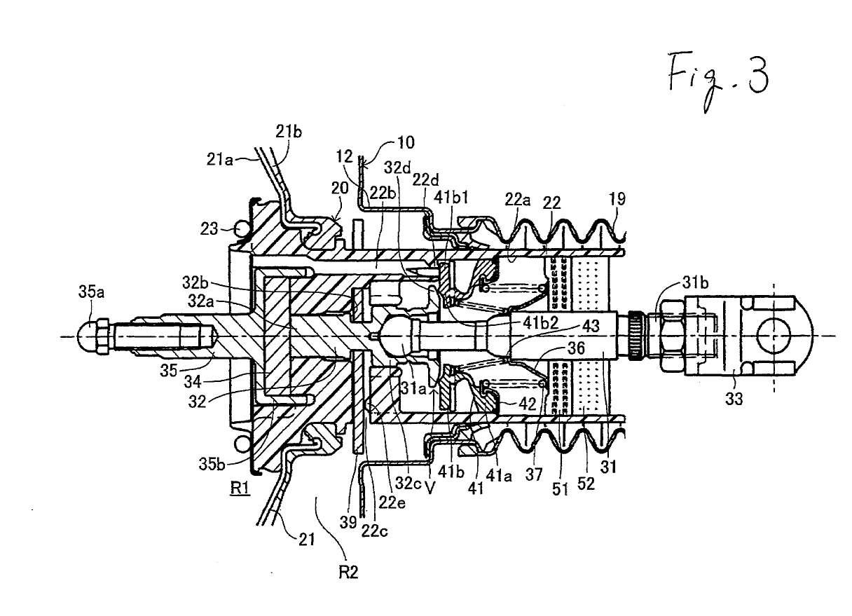

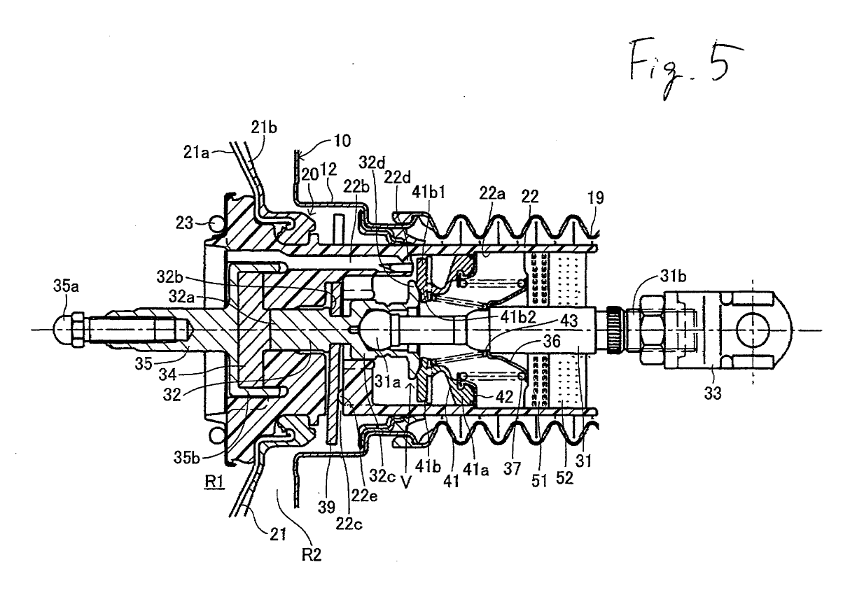

However, in the first embodiment, as illustrated in FIGS. 1 and 2, a pair (two) of protrusions 22e having the same shape as each other are integrally provided in the valve body 22. Each of the protrusions 22e is formed in the key mounting hole 22c. Accordingly, when the valve body 22 is in the forward moving position (the operating state position) and the plunger 32 is moved rearward from the forward moving position (in other words, when moving from the state illustrated in FIG. 3 to the state illustrated in FIG. 5), the key member 39 is tilted and held with respect to the valve body 22 with a required amount.

In the vacuum brake booster of the first embodiment configured as described above, at an initial stage of the period in which the valve body 22, the plunger 32, the key member 39 and the like are returned from the operating state (the state illustrated in FIG. 3) thereof to the non-operating state (the state illustrated in FIG. 1), the key member 39 is tilted and held with respect to the valve body 22 by the protrusions 22e (a pair (two) of protrusions 22e having the same shape as each other are provided in the valve body 22), when the plunger 32 is moved rearward with the key member 39 from the forward moving position with respect to the valve body 22 which is in the forward moving position (the operating state position) (see, FIGS. 3 to 5).

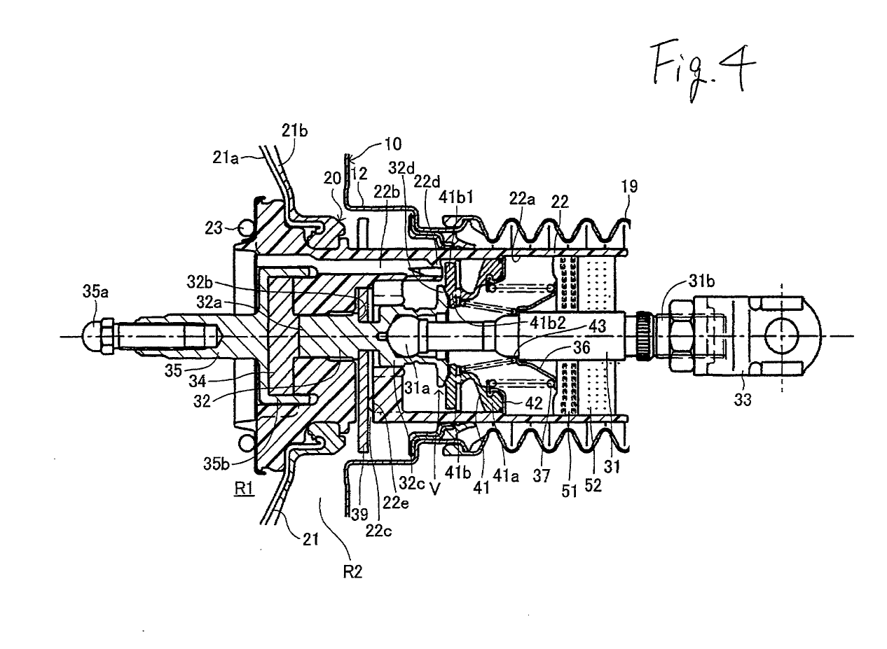

For this reason, when the key member 39 illustrated in FIG. 3 abuts the valve body 22 as illustrated in FIGS. 4 and 5, an one-step abutment (the abutment in a plane) is prevented and then a two-step (a multi-step) abutment (the abutment between the key member 39 and the protrusions 22e when starting the tilt illustrated in FIG. 4, and the abutment between the key member 39 and a wall surface (a portion other than the protrusion of the valve body 22) of the key mounting hole 22c when finishing the tilt illustrated in FIG. 5) can be obtained. Accordingly, at the initial stage of the returning operation, an impact can be distributed when the key member 39 abuts the valve body 22 so that a hitting sound (a hitting sound when the key member 39 abuts the valve body 22) can be reduced at the initial stage of the returning operation.

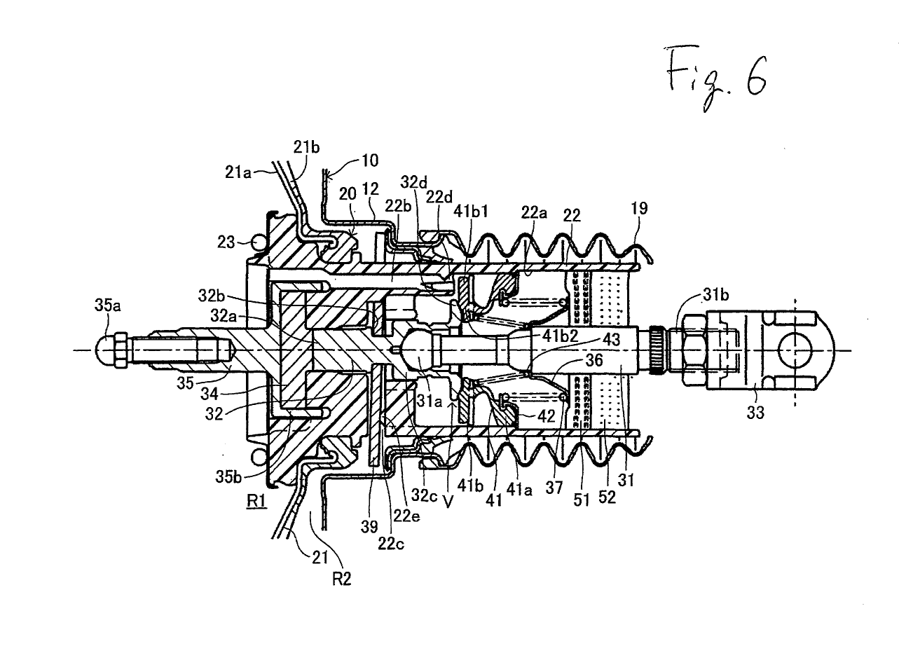

In addition, in the vacuum brake booster of the first embodiment, at the late stage in which the operating state returns to the non-operating state, the key member 39 is returned with respect to the valve body 22 from a tilt holding state to a returned state (a standing state), when the key member 39 abuts the housing 10 (the rearward shell 12) (see, FIGS. 6 and 1). Thus, also at this time, the one-step abutment (the abutment in a plane) is prevented and then the two-step abutment (the abutment in the tilt holding state illustrated FIG. 6 and the abutment immediately before returning to the returned state illustrated FIG. 1) can be obtained. Accordingly, at the late stage of the returning operation, since the impact can be distributed when the key member 39 abuts the housing 10, the hitting sound (the hitting sound when the key member 39 abuts the housing 10) at the late stage of the returning operation can be reduced.

Incidentally, since the impact is distributed when the key member 39 abuts the valve body 22 at the initial stage of the returning operation and the impact is distributed when the key member 39 abuts the housing 10 at the late stage of the returning operation, the functional effects described above can be stably obtained without secular change. Accordingly, in the vacuum brake booster of the first embodiment, the hitting sound of the initial stage of the returning operation and the hitting sound of the late stage of the returning operation can be effectively reduced for a long term.

In addition, in the vacuum brake booster, other than the both hitting sounds described above (the hitting sound which occurs when the key member 39 abuts the valve body 22 and the hitting sound which occurs when the key member 39 abuts the housing 10), the hitting sound relating to the key member 39, which occurs during returning operation includes a hitting sound which occurs when the plunger 32 abuts the key member 39 (a hitting sound which occurs before the key member 39 abuts the valve body 22 (while moving from the state illustrated in FIG. 3 to the state illustrated in FIG. 4)) and a hitting sound which occurs when the valve body 22 abuts the key member 39 (a hitting sound which occurs after the key member 39 abuts the housing 10 (while moving from the state illustrated in FIG. 6 to the state illustrated in FIG. 1)); however, since the hitting sounds are small compared to the both hitting sounds described above, it is not much problem.

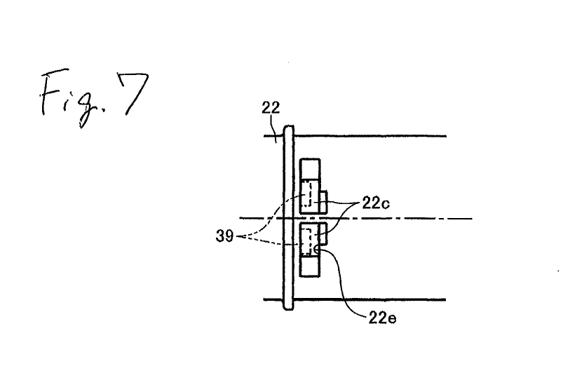

In the first embodiment described above, the invention is embodied in which a pair (two) of the protrusions 22e having the same shape as each other are provided in the valve body 22; however, the shapes of the protrusions may be different from each other and the number of the protrusions may be appropriately changed (for example, as illustrated in FIG. 7, the number of the protrusion 22e is one) when embodying the invention. In addition, in a case where the invention is embodied in which the number of the protrusion 22e is one, since the key member 39 can be tilted and held on the paper surface illustrated in FIG. 7, the distribution of the impact described above can be increased compared to the embodiment described above.

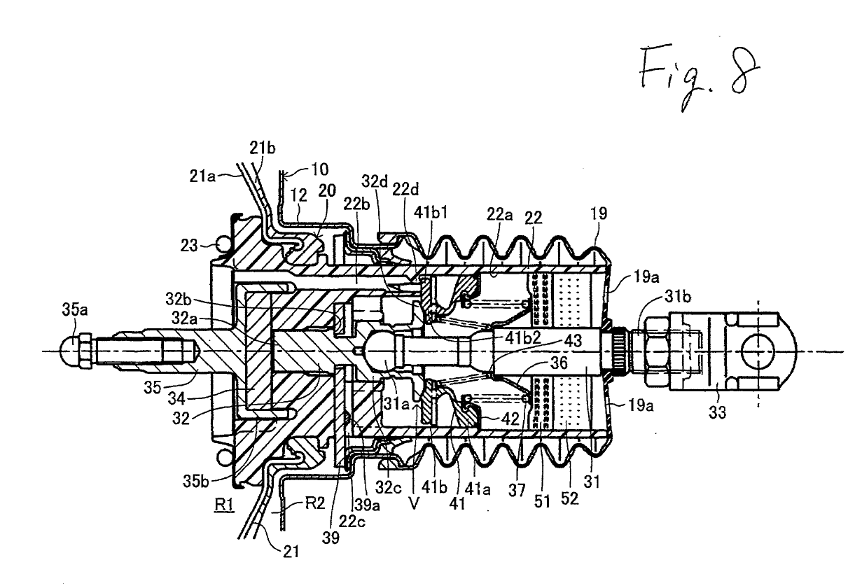

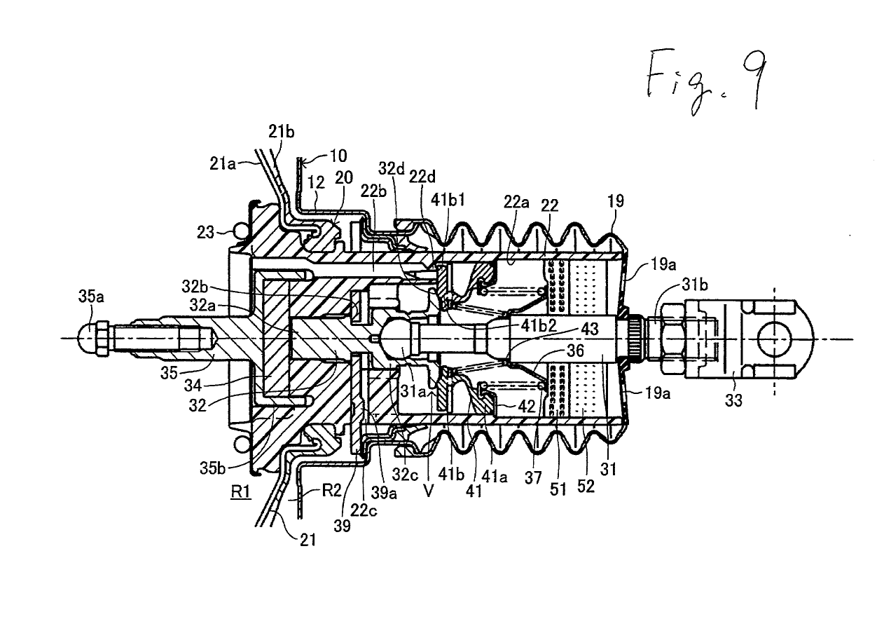

In addition, in the first embodiment described above, the invention is embodied in which the protrusions 22e which tilt and hold the key member with respect to the valve body are provided in the valve body 22, when the valve body is in the forward moving position and the plunger is moved rearward from the forward moving position; however, when embodying the invention, as in a second embodiment illustrated in FIG. 8 or a third embodiment illustrated in FIG. 9, a protrusion 39a corresponding to the protrusion 22e described above may be provided in the key member 39. In the second embodiment illustrated in FIG. 8, the protrusion 39a is formed of an elastic material and fixed to the key member 39. Meanwhile, in the third embodiment illustrated in FIG. 9, the protrusion 39a is formed at the key member 39 by using a press molding.

In addition, in each of the embodiments described above, the invention is embodied in the single type vacuum brake booster; however, the invention can be embodied in a tandem type vacuum brake booster similar to each of the embodiments described above or by changing appropriately. The invention is not limited to the embodiments described above.

As mentioned above, according to the invention, the protrusion described above may be provided in the valve body and may be provided in the key member. In addition, the protrusion provided in the key member may be formed of an elastic material and fixed to the key member. In addition, the protrusion provided in the key member may be formed in the key member by using a press molding in a case where the key member is made of a metal.

Furthermore, In the vacuum brake booster of the invention, at an initial stage of the period in which the valve body, the plunger, the key member and the like are returned from the operating state thereof to the non-operating state, the key member is tilted and held with respect to the valve body by the protrusions (provided in the valve body or the key member), when the plunger is moved rearward with the key member from the forward moving position with respect to the valve body which is in the forward moving position (the operating state position). Thus, when the key member abuts the valve body, a one-step abutment (abutment in a plane) is prevented and then a number (a multi-step) of abutments (at least, the abutment when starting the tilt and the abutment when finishing the tilt) can be obtained. Accordingly, at the initial stage of the returning operation, an impact can be distributed when the key member abuts the valve body so that a hitting sound can be reduced at the initial stage of the returning operation.

In addition, in the vacuum brake booster of the invention, at the late stage of the period in which returning from the operating state to the non-operating state, the key member is returned with respect to the valve body from a tilt holding state to a returned state (a standing state), when the key member abuts the housing. Thus, also at this time, the one-step abutment (the abutment in a plane) is prevented and then a number of (the multi-step) abutments (at least, the abutment in the tilt holding state and the abutment in the returned state) can be obtained. Accordingly, at the late stage of the returning operation, since the impact can be distributed when the key member abuts the housing, the hitting sound at the late stage of the returning operation can be reduced.

Incidentally, since the impact is distributed when the key member abuts the valve body at the initial stage of the returning operation and the impact is distributed when the key member abuts the housing at the late stage of the returning operation, the functional effects obtained in the vacuum brake booster according to the invention can be stably obtained without secular change. Accordingly, in the vacuum brake booster of the invention, the hitting sound of the initial stage of the returning operation and the hitting sound of the late stage of the returning operation can be effectively reduced for a long term.

What is claimed is:

1. A vacuum brake booster comprising:
a movable partition wall which defines a forward negative pressure chamber and a rearward variable pressure chamber within a housing;
a valve body which is retractably assembled in the housing and connected to the movable partition wall inside the housing;
a valve mechanism having a negative pressure valve which is assembled inside a shaft through hole included in the valve body and which communicates and cuts off between the negative pressure chamber and the variable pressure chamber, and an atmosphere valve which communicates and cuts off between the variable pressure chamber and the atmosphere;
a plunger which configures a portion of the valve mechanism and which is retractable with respect to the valve body in an axial direction, thereby integrally moving with an input member;
a reaction member which is assembled inside the shaft through hole forward from the plunger such that a front end portion of the plunger and a front end portion of the valve body are engageable with its rear surface;
an output member of which a rear end portion engages with a front surface of the reaction member and which is movable with respect to the valve body in the axial direction;
a key member which is able to engage and disengage with respect to the valve body, the plunger and the housing, and which defines a moving amount of the plunger with respect to the valve body in a front-back direction, and which defines a rearward moving limit position of the valve body with respect to the housing; and
a protrusion tilting and holding the key member with respect to the valve body when the valve body is in the forward moving position and the plunger is moved rearward from the forward moving position.

2. The vacuum brake booster according to claim 1, wherein the protrusion is provided in the valve body.

3. The vacuum brake booster according to claim 1, wherein the protrusion is provided in the key member.

4. The vacuum brake booster according to claim 3, wherein the protrusion is formed of an elastic material and fixed to the key member.

5. The vacuum brake booster according to claim 3, wherein the key member is made of a metal and the protrusion is formed in the key member by using a press molding.
